(19) United States
(12) Patent Application Publication
(10) Pub. No.: US 2008/0057776 A1
(43) Pub. Date: Mar. 6, 2008

(54) LOW-COST INTERCONNECTION SYSTEM FOR SOLAR ENERGY MODULES AND ANCILLARY EQUIPMENT

(75) Inventor: Eric Bryant Cummings, Livermore, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CoolEarth Solar, Livermore, CA (US)

(21) Appl. No.: 11/843,549

(22) Filed: Aug. 22, 2007

Related U.S. Application Data
(60) Provisional application No. 60/839,855, filed on Aug. 23, 2006.
(60) Provisional application No. 60/839,841, filed on Aug. 23, 2006.
(60) Provisional application No. 60/840,156, filed on Aug. 25, 2006.
(60) Provisional application No. 60/840,110, filed on Aug. 25, 2006.

(51) Int. Cl. H01R 4/00; F16L 53/00; F16L 55/02; F16L 9/19

(52) U.S. Cl. 439/382; 138/141; 138/177; 285/119; 285/41

(57) ABSTRACT

Embodiments in accordance with the present invention relate to inexpensive, manufacturable, robust, and easily installed interconnections for solar energy conversion systems. Particular embodiments in accordance with the present invention provide a convenient and low-cost means of interconnecting between one or more of solar energy modules and ancillary equipment electrical, hydraulic, pneumatic, and mechanical connections including one or more power-bearing electrical wires, cooling water conduits, compressed air conduits, electronic control and networking circuitry, conduits for chemical reactants and products, and mechanical linkages. Particular embodiments are further suitable for vibration control and damping of structures.

### CROSS-REFERENCES TO RELATED APPLICATIONS

The instant nonprovisional patent application claims priority to U.S. Provisional Patent Application No. 60/839,855, filed Aug. 23, 2006 and incorporated by reference in its entirety herein for all purposes. The instant nonprovisional patent application is also related to the following provisional patent applications, each of which is incorporated by reference herein for all purposes: Appl. No. 60/839,841, filed Aug. 23, 2006; Appl. No. 60/840,156, filed Aug. 25, 2006; and Appl. No. 60/840,110, filed Aug. 25, 2006.

### BACKGROUND OF THE INVENTION

Solar radiation is the most abundant energy source on earth. However, attempts to harness solar power at large scales has so far failed to be economically competitive with most fossil-fuel energy sources. One possible reason for this is that the solar flux is not intense enough for direct conversion at one solar flux to be cost effective.

Solar concentrator technology seeks to address this issue. Solar radiation is one of the most easy energy forms to manipulate and concentrate. It can be refracted, diffracted, or reflected to many thousands of times the initial flux, using only modest materials.

With so many possible approaches, a multitude of solar concentrator approaches have been proposed. So far, however, such conventional solar concentrator systems cost too much to compete unsubsidized with all fossil fuels.

One reason for this is that the cost of the various systems that must be interconnected to concentrators. Specifically, liquid cooled photovoltaic concentrators may typically require connections for electricity and cool and hot liquid. Some concentrators may further require inflation air and signaling connections. The cost in labor and components to make separate connections for everything in the field can be prohibitive.

Moreover, the structure to service solar concentrators is conventionally material intensive. Specifically, conventional concentrator designs have adopted wiring harness, umbilical cord, and discrete interconnections that generally require greater material use and more installation time.

Accordingly, there is a need in the art for improved designs for connecting solar concentrators, which exhibit greater simplicity and less intensive consumption of materials.

### BRIEF SUMMARY OF THE INVENTION

Embodiments in accordance with the present invention relate to inexpensive, manufacturable, robust, and easily installed interconnections for solar energy conversion systems. Particular embodiments in accordance with the present invention provide a convenient and low-cost means of interconnecting between one or more of solar energy modules and ancillary equipment electrical, hydraulic, pneumatic, and mechanical connections including one or more power-bearing electrical wires, cooling water conduits, compressed air conduits, electronic control and networking circuitry, and mechanical linkages. The structure of the interconnection hardware can additionally provide damping of mechanical vibrations.

Embodiments in accordance with the present invention may offer one or more benefits over existing approaches. One such possible advantage is reduction in overall cost, so that solar concentrators can provide affordable, clean energy. A multielement cable in accordance with embodiments of the present invention can also provide damping of material efficient structures, and can provide inexpensive large area heat exchangers to keep coolant temperature rise above ambient to a minimum. To offset labor costs, embodiments of the present invention employ novel designs to simplify and speed installation and maintenance.

An embodiment of an apparatus in accordance with the present invention comprises a multiple-element cable containing at least one fluid conduit and a connection selected from an electrical connection, a mechanical connection, and an optical connection, wherein the fluid conduit is defined by a cavity in a web material of the cable.

An alternative embodiment of an apparatus in accordance with the present invention comprises a heat exchanger integrated within a cable housing a connection selected from an electrical connection, a pneumatic connection, a mechanical connection, an optical connection, and a hydraulic connection.

An embodiment of a connector in accordance with the present invention is configured to mechanically fasten around a cable containing at least one fluid conduit and a connection selected from an electrical connection, a mechanical connection, and an optical connection, the connector establishing a first shunt with the fluid conduit and a second shunt with the connection.

An embodiment of a method in accordance with the present invention of dampening vibration of a truss, comprises, connecting a cable having a cavity configured to be partly filled with a material to at least one tensile truss element.

An embodiment of a method in accordance with the present invention of controlling a temperature of a suspended solar energy collector, comprises, connecting the airborne solar energy collector through a connector having a cavity containing a heat-exchanging material.

These and other embodiments of the present invention, as well as its features and some potential advantages are described in more detail in conjunction with the text below and attached figures.

### BRIEF DESCRIPTION OF THE DRAWINGS

FIG. 1 shows a perspective view of an embodiment of the present invention.

FIG. 2 is a perspective view showing the use of a single primary multi-element cable to service multiple clients via secondary multi-element cables.

FIGS. 3A-3BA show diagrams of the cavities between bonded regions of a multi-element cable and the resulting cable when these cavities contain pressurized fluids.

FIG. 4 shows a perspective view of a uniform multi-element cable and connector according to an embodiment of the present invention.

FIGS. 5A-B show perspective and enlarged views, respectively, of a non-uniform multi-element cable that supports specific connector sites according to an embodiment of the present invention.

FIGS. 6A-B show perspective and enlarged views, respectively, of a diagram of a breakout connector mounted to the cable of FIGS. 5A-B.

FIG. 7 shows an exploded view of components of an embodiment of a breakout connector according to an embodiment of the present invention.

FIG. 8A shows a simplified diagram of a multi-element cable assembly in accordance with an embodiment of the present invention, as rolled, extruded, or bonded.

FIG. 8B shows a simplified cross-sectional diagram of an embodiment of a multi-element cable assembly in accordance with an embodiment of the present invention in operation, with fluid conduits inflated.

FIG. 8C shows an alternative cross-sectional diagram of a multi-element cable assembly in accordance with an embodiment of the present invention exhibiting reduced effect of coolant weight on channel inflation.

FIG. 8D shows an alternative embodiment of a multi-element cable assembly in accordance with the present invention using multiple tensile elements to minimize effect of coolant weight on channel inflation.

FIG. 9A shows a simplified view of a multi-element cable connector in accordance with an embodiment of the present invention that terminates in separate wires and tubes.

FIG. 9B shows a simplified view of a multi-element cable connector in accordance with an embodiment of the present invention that terminates in interconnection standards.

FIG. 9C shows a simplified view of a multi-element cable connector in accordance with an embodiment of the present invention that terminates in an application specific conduit assembly.

FIG. 9D shows a simplified view of a cable splice or paralleling connector in accordance with an embodiment of the present invention.

FIG. 9E shows a simplified view of a blank connector in accordance with an embodiment of the present invention.

FIG. 10 is a diagram illustrating the coupling between vibratory motion of an embodiment of the multi-element cable according to the present invention and the oscillatory fluid pumping motion within conduits of that cable.

FIGS. 11A-C are diagrams showing an alternative multi-element cable arrangement according to the present invention that redistributes inertial mass or utilizes a separate mechanical cable to enhance damping characteristics.

FIGS. 12A-B are plan and perspective views, respectively, showing a multi-element cable according to an embodiment of the present invention, in which tortuous flow paths are patterned into the conduits to trap gas pockets and enhance damping.

FIGS. 13A-D are views showing liquid-gas interfaces inside the channels of the cable in FIGS. 12A-B, at various orientations with respect to gravity.

### DETAILED DESCRIPTION OF THE INVENTION

Embodiments in accordance with the present invention relate to inexpensive, manufacturable, robust, and easily installed interconnections for solar energy conversion systems. Particular embodiments provide a convenient and low-cost approach to establishing interconnections between one or more solar energy modules and ancillary equipment electrical, hydraulic, pneumatic, and mechanical connections including power-bearing electrical wires, cooling water conduits, compressed air conduits, electronic control and networking circuitry, and mechanical linkages. As used herein, an object that connects to a cable according to an embodiment of the present invention (e.g., a solar concentrator) is referred to as a “client.” The client may connect to a “primary” multi-element cable through a “secondary” multi-element cable.

One objective of embodiments according to the present invention is to provide economical interconnection support for solar energy modules to be incorporated into systems for solar energy farming. Such modules generally require multiple electrical, hydraulic, pneumatic, and mechanical linkages including those for:

electrical power,

cooling air or water,

inflation air,

electrical monitoring and networking, and

mechanical pointing or support.

Moreover, for such solar energy farming applications, it may be desirable to minimize the usage of material for mechanically supporting the solar energy collection apparatus. However, low-material-use structures tend to lack the stiffness of more conventional structures and consequently are susceptible to large-amplitude vibrations resulting from wind forces and the like without mechanisms of vibration damping.

The architecture of a multi-element cable in accordance with an embodiment of the present invention provides for efficient and effective vibration damping with little or no additional cost in manufacturing or operation. Particular embodiments of the multi-element cable structures according to the present invention may serve as such effective dampers in a sufficiently cost-effective manner, that they may be employed for damping with or without taking advantage of their other capabilities.

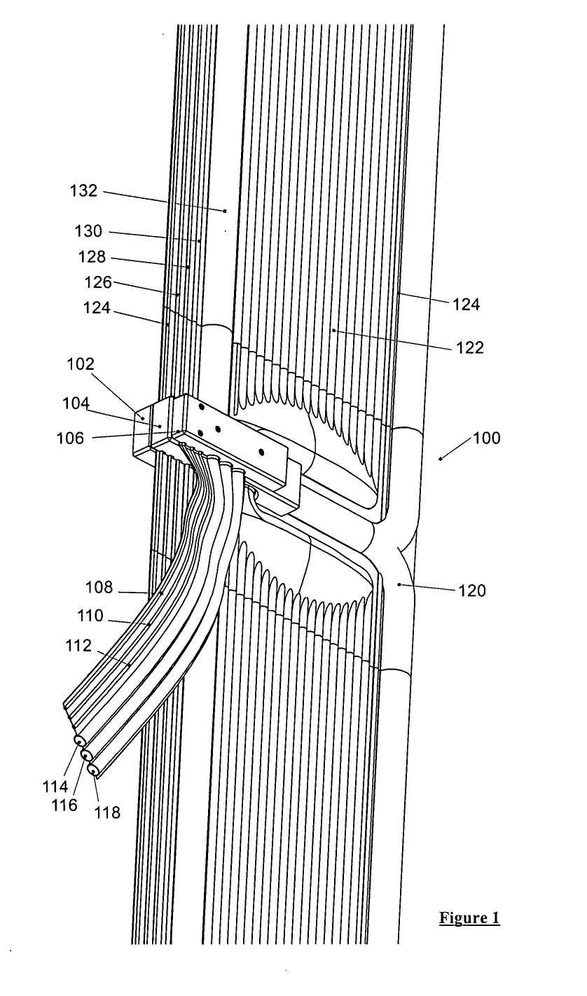

FIG. 1 shows a sketch of a typical embodiment of a connector 100 in accordance with the present invention. In this embodiment, mechanical 124, air 120, hot water 122, cool water 132, electrical 126, 128 and electronic signaling 130 connections pass through a primary multi-element cable and are coupled to a client (not shown) via a connector assembly 102, 104, 106 through a secondary multi-element cable containing conduits for air 118 hot water 116, cool water 114, signaling and sensing 112, and electrical connections 108, 110. In this embodiment, the secondary cable could serve one or more clients including solar concentrator modules directly or via other connectors according to the present invention.

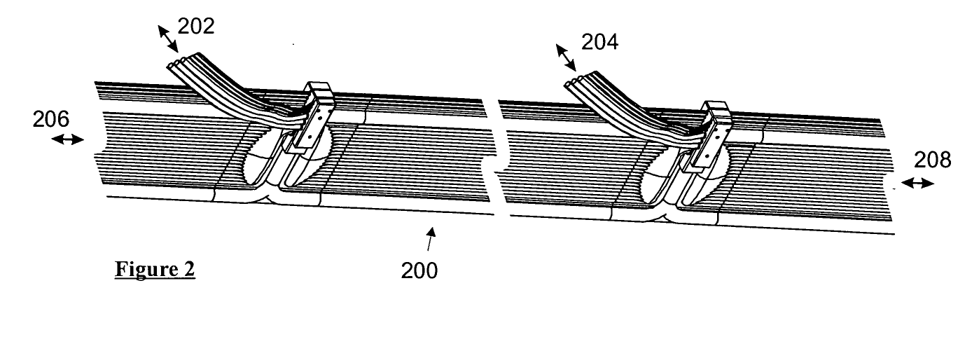

As shown in FIG. 2, the primary cable 200 could serve a plurality of solar concentrator clients in which elements 206 and 208 from the primary cable are coupled to multiple secondary ports 202, 204 through a combination of series and parallel connections.

As used herein, the term “conduit” refers to an entity that facilitates transport of a “signal,” a “signal” is anything to be transported, and “transport” is the process of spatially displacing a signal. This general nomenclature is needed because of the variety of signal types transported through the conduits according to the present invention, e.g., mechanical forces through ropes and cables; electrical current through wires; data signals transported in the form of electrical waveforms through twisted pairs, or optical waveforms through plastic or glass fiber optics, etc.; coolant, thermal working fluid, inflation air, hydraulic liquids, and other liquids including reactants and products of chemical reactions through hollow conduits, etc.

The connector assembly (e.g., elements 102, 104, 106 of FIG. 1) and the multi-element cables contain features, plena, channels, conduits, cutouts, etc., to link individual connections in series or parallel as needed for the function of the system. For example, the electrical outputs of the concentrators may be wired in series so that the voltages add along the sequence, rather than the currents. However, it may be preferable to connect the cool and hot water lines in parallel to each concentrator so that the coolant feed temperature does not increase along the sequence. Alternatively, if the intent of the array is to warm a working fluid, it may be advantageous to connect working fluid in series so that the temperature increases along the series.

The connector assembly and multi-element cables can further contain active and passive elements that perform a range of functions related to operation, safety, servicing, diagnostics, performance enhancement and the like. These functions include, but are not limited to:
incorporating a bypass diode to provide an alternate current path past a concentrator if the concentrator is disabled, shaded or absent;
incorporating mechanical check valves to provide for substantially one-way flow of fluid, e.g., to prevent back flow or leakage and to prevent catastrophic coolant loss in a concentrator client under cooling-system fault conditions;
providing for bypassing or blocking flow when a connector or cable is missing;
providing pressure, temperature, acceleration, and voltage or current sensing analog or digital signals;
incorporating valves for metering and routing fluid flow;
incorporating passive and active pressure regulators;
incorporating passive and active thermostatic flow regulators;
incorporating pressure-relief devices, e.g., burst disks and over-pressure valves;
incorporating microcontrollers, microprocessors, or other specialized active control circuitry;
incorporating membranes, screens, mesh, or other mechanical filters to remove particulates from liquids;
incorporating membranes, dessicants, resins, and other gettering materials to remove unwanted chemicals or materials from liquid streams, e.g., to lower the humidity of inflation air or remove chemicals that can contribute to scale or corrosion;
provide receptacles for storage of reactants, and intermediate or final chemical reaction products produced or utilized by clients;
provide for producing bolus or droplet discretized flows of chemicals in the manner of flow injection analysis for contamination, dispersion, and mixing control;
provide liquid chambers for control of vibration frequency and amplitude, e.g., via liquid sloshing, tuned liquid column damping, resonant frequency modification;
provide for actively or passively controlled or uncontrolled injection of gas into liquid streams, e.g., to enhance vibration damping function; and
provide flexible chambers to enhance vibration damping and to avoid damage from liquid freezing.

Embodiments in accordance with the present invention disclose the use of extrusions and bonded films fabrics, and the like to produce a single flexible multi-element cable that supports a plurality or totality of these linkages or conduits. Other embodiments in accordance with the present invention disclose connectors that tap into one or more of these linkages or conduits to service a solar module. These connectors can be incorporated into the multiple-element cable during assembly or they can be installed in the field. As used herein, “incorporated” means assembled during the manufacturing process or in a factory, while “installed” means assembled by an end user or installer, generally in the field or a less-specialized facility.

The multi-element cable can be such that one or more elements or conduits are enveloped, supported, and protected. Such elements or conduits include but are not limited to copper wires, aluminum wires, steel cable or wire, stainless steel cable or wire, Kevlar fibers, glass fibers, carbon fibers, electrical cable assemblies, network assemblies, fiber optics and fiber-optic assemblies, flexible tubes, vacuum-jacketed tubes, insulated tubes, etc. Cavities manufactured in the cable can directly provide conduits for fluids such as cooling water and inflation air, as well as hydraulics or pneumatics for actuation. The multi-element cable can further function as a distributed heat exchanger to atmospheric air and a mechanical vibration damper.

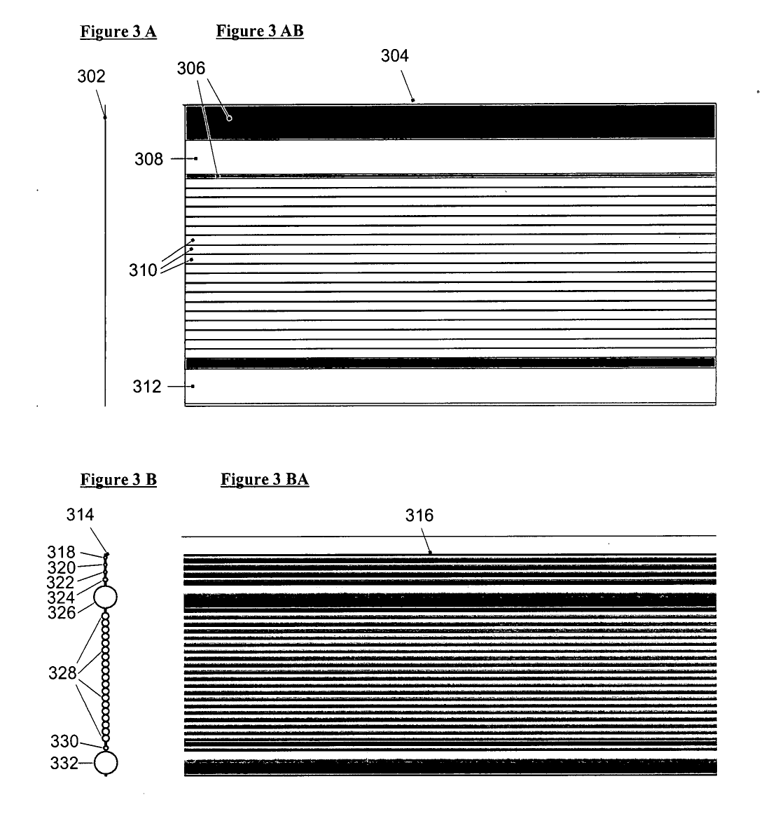

One embodiment of a method of enveloping elements and forming cavities is extrusion of a plastic web and wall material around the elements and past an appropriately designed mandrel. Another method is to laminate these elements in films as shown in FIGS. 3A-3BA.

Specifically, FIGS. 3A-3AB show end and side views respectively, of a film that is initially substantially flat that will be bonded in the gray regions 306 to another film such that regions 308, 310, and 312 remain unbonded. FIGS. 3B and 3BA show end and side views respectively, of the resulting cable assembled from the film in FIG. 3A-AB, with electrical, electronic, and mechanical conduits in place. The unbonded regions 326, 328 and 332 inflate under internal pressure into fluid conduits.

As used herein, “films” include but are not limited to materials that are substantially thinner in one dimension than others, e.g., plastic, metal, and composite films; impregnated or native fiberglass, carbon fiber, metal fiber, natural fiber, and polymer fiber random and oriented mattes, weaves, knits, and various composite materials assembled from at least one of these elements. Preferred films include PVF, TEDLAR, acrylic, polyester and vinyl-impregnated fabrics including canvas, nylon, DACRON (polyester) and other long-life outdoor, and other woven or random fibrous materials. Films can be modified for improved outdoor performance by coating, painting, or incorporating materials to absorb or reflect ultraviolet light or inhibit damage from ultraviolet light (UV), e.g., hindered amine light stabilizers and to inhibit oxidation and rust, through various materials and treatments well known in the art.

As used herein, the term web denotes the material surrounding conduits in the assembled cable. Web materials may comprise films and assemblies of laminated films as defined above.

Cavities can be made in unlaminated slots between regions bounded by two film surfaces, as shown by the white regions 308, 310, and 312 in FIG. 3AB, and their respective regions 336, 328, and 332 in FIG. 3BA. The two film surfaces could be part of the same film, e.g., one film folded over on itself or two separate films, or an assembly of more than two films stacked on top of each other, straddling each other, overlapping, or non-overlapping, of the same material or of dissimilar materials or construction. The gray regions e.g. 306 and others of FIG. 3AB are bonded or mated together. Such unlaminated slots can be produced by not applying laminating adhesive, stitching, or other mechanical fasteners to these regions, blocking the adhesive function or peeling off the adhesive in these regions, inserting a hollow thin-walled tube (e.g., flat tube), thick-walled tube, or sacrificial material in these regions or not activating the adhesive in these regions, e.g., not applying heat and/or pressure to a heat seal, not applying ultraviolet light to an ultraviolet light initiated adhesive, etc.

Under the combined influence of internal pressure, mechanical rigidity of the native film material or rigidity of inserted or incorporated materials, the regions indicated by white in FIG. 3AB form at least one conduit. In the embodiment 302 of the invention depicted in FIGS. 3A-BA, the conduit 318 contains a mechanical cable, e.g., a wire rope used to reinforce and support the multi-element cable; 320 and 322 hold electrical wires; 324 contains wires for networking and electronic sensing, signaling, and control; 326 forms a cavity for conveying cooling water; 328 are multiple cavities for conveying hot water from the concentrators; 330 holds a secondary mechanical cable; and 332 is a cavity for conveying inflation air. The cavities 328 are arranged to increase surface area to enhance heat transfer. The ordering size, presence and absence of these conduits or the presence of additional conduits of a different nature depends on the specifics of the application.

The ordering shown in FIGS. 3A-BA favorably supports an inflated concentrated photovoltaic module. The power-bearing electrical wires are physically isolated from the coolant lines. The large cool-water conduit eliminates pressure losses. Proximity of the large cool water conduit to the mechanical cable prevents its mass from distorting the hot-water lines. For enhanced vibration damping at the expense of higher pumping losses, the large cool-water conduit could be placed below these smaller heat-exchanger channels. A secondary mechanical connector 330 may be favorable to inhibit flapping or fluttering or to enhance vibration damping performance. The inflation air conduit at the bottom is favorable since the conduit does not need to use inflation air pressure to resist distortion from the mass of conduits that lie below the cable.

The web and wall material must be able to withstand stresses associated with internal pressures including fault pressures, e.g., caused by freezing of coolant lines, etc, the weight of material supported by the cables, wind forces, and inertial forces produced, e.g., from flutter among others, while withstanding the maximum operating temperatures of the system. The entire spectrum of potential film materials and composites of materials can be employed to engineer a multi-element cable according to constraints of cost, reliability, temperature range, environmental conditions, and the like. Polyester (PET) is a good candidate for such materials because of its strength, rigidity, low cost, and high-temperature operation. However, PET does not thermally bond well without a co-extruded heat seal layer, which will lower the service temperature. Thus PET webs for high-temperature cable assemblies may need to be extruded, ultrasonically welded. Moreover, PET can have poor ultraviolet light tolerance, so protection from UV is of greater importance than, e.g., for a polyvinylfluoride (PVF) or acrylic film that has native UV resistance.

Adhesive bonds between films can be enhanced, as known in the art by a variety of treatments, including mechanical abrasion, corona treatment, priming, e.g., with polyethyleneimine (PEI), hot coextrusion with a heat-seal or reactive polymer, and a plethora of techniques and processes well known in the art. The film materials may need to be specially formulated or blended from heterogeneous materials to provide for enhanced thermal or mechanical performance, e.g., compliance but limited creep over an extended temperature range.

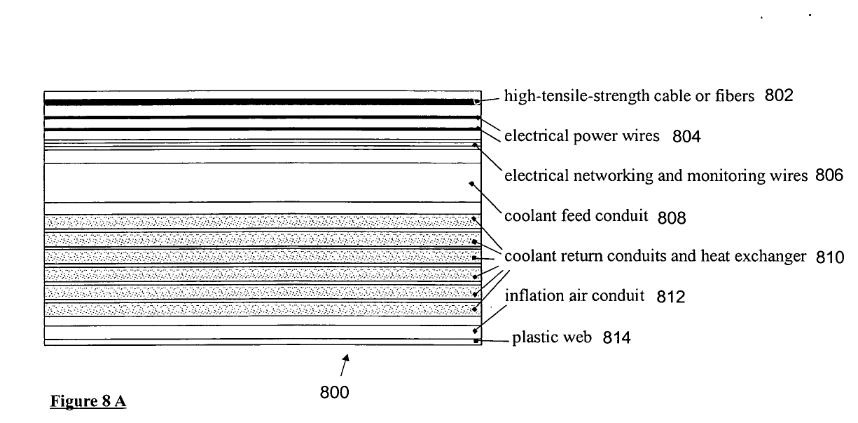

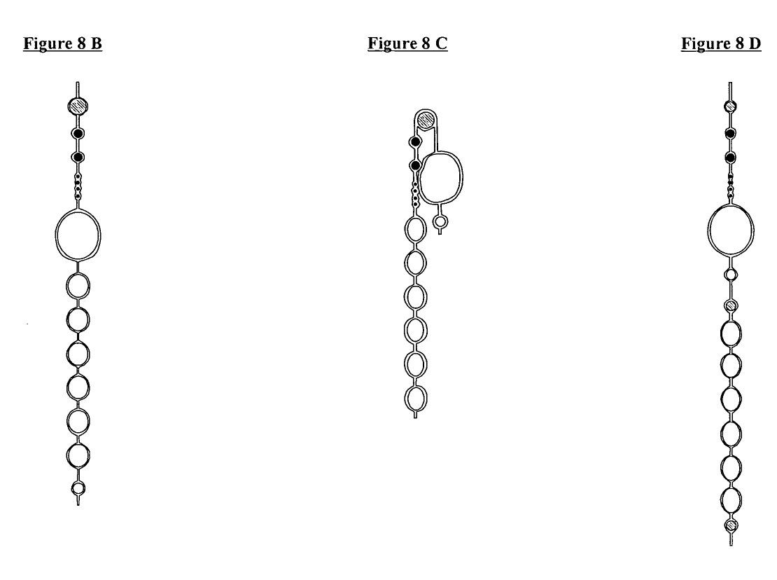

FIGS. 8A-D show diagrams of a multi-element cable assemblies in accordance with embodiments of the present invention. FIG. 8A shows an assembly as rolled, extruded, or bonded. Cable 800 high-tensile-strength cable or fibers 802, electrical power wires 804, electrical networking an monitoring wires 806, coolant feed conduit 808, coolant return conduits and heat exchanger 810, inflation air conduit 812, and plastic web 814.

FIG. 8B is a simplified cross-sectional view showing the embodiment of FIG. 8A in operation with fluid conduits inflated. FIG. 8C shows an alternative cross-sectional view for reduced effect of coolant weight on channel inflation. FIG. 8D shows an alternative assembly using multiple tensile elements to minimize effect of coolant weight on channel inflation.

In alternative or addition to incorporated mechanical tensile elements, such cables could be installed to apparatus using a variety of well known conventional fasteners, e.g., grommets, hooks, cable ties, laces, Velcro, tabs, etc.

Interconnects and a separate support cable are conveniently mounted together, and a hot-water (or coolant)/air heat exchanger is integrated into the cable. The dot pattern on the hot-water conduits indicate an optional array of microscopic (e.g., 100 μm or smaller) holes or region of gas-permeable film. This feature can provide for a passive or controlled conversion from conventional convective heat transfer to transpirational heat transfer if the coolant temperature becomes excessively high.

Because the fluid channels require internal pressure to widen, it may be advantageous to arrange them in an alternative way, as in FIG. 8C so that the weight of the coolant in the channels has a minimal effect on the inflation of the other channels. Folding the cable over as shown also reduces windage, however it complicated interconnections.

FIG. 8D shows a preferred arrangement which contains multiple tensile elements to isolate the flow channels from each other and facilitate interconnection by forming index or reference positions to locate the cable elements accurately in cable connectors.

If the purpose of the high-tensile-strength cable or fibers is to hold the weight of the cable assembly itself, this function can alternatively be provided by the electrical power wires and the strength of the web material itself. However, if the multiple-element cable must support greater loads, e.g., withstand wind loading on sun-tracking solar modules, or if the electrical wires cannot be continuous, as with connections for series-connected modules, separate high-tensile-strength elements may be necessary.

One clearly advantageous way to distribute a multi-element cable is in the form of a roll. In accordance with such embodiments, the connections must be installed in the field. A further element of certain embodiments in accordance with this invention is a multi-element or family of multi-element cable connectors that can be readily installed using a tool or tools.

Such a cable could be distributed with cutouts and or markings to facilitate simple and accurate connector placement. Alternatively, multi-element cables can be distributed in the form of a somewhat larger roll with all or part of the connectors preassembled. The incorporation of critical connector components can provide for faster, higher-quality, more repeatable, and longer lasting connections than can be readily achieved in the field.

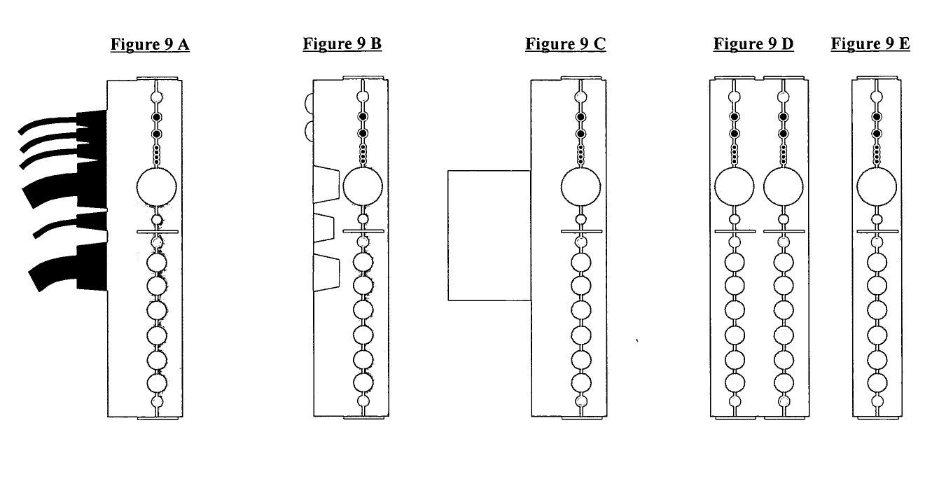

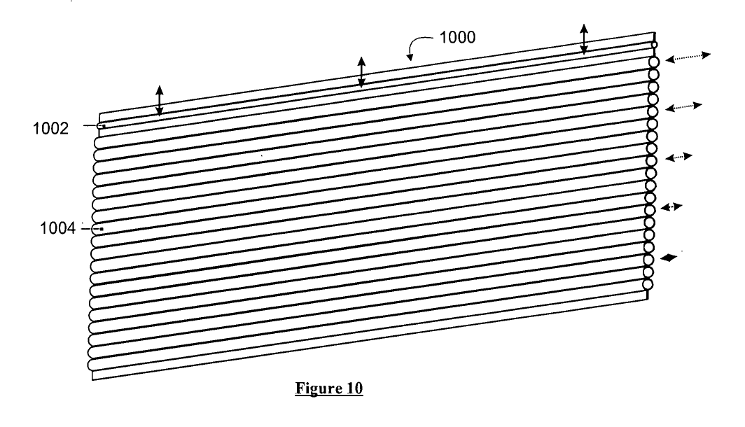

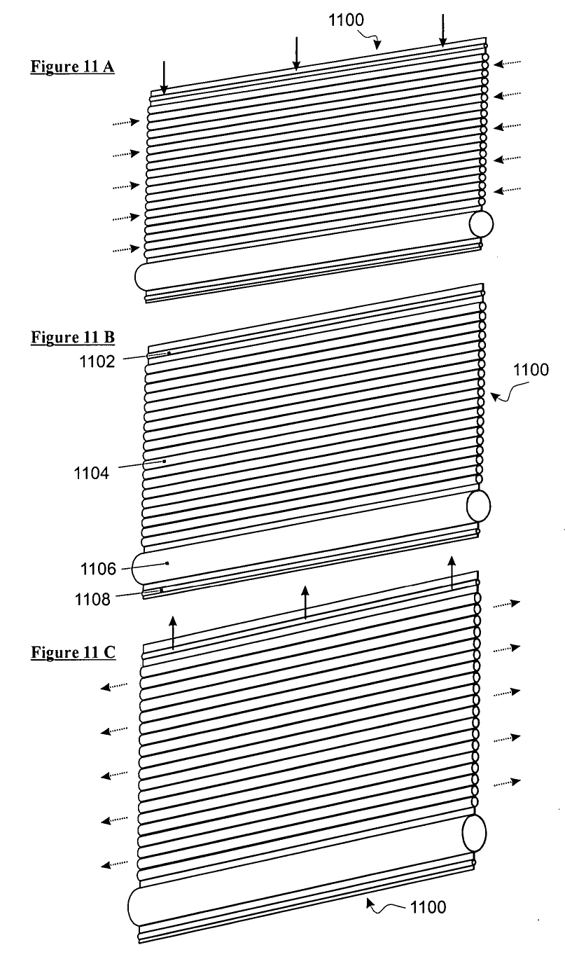

FIGS. 9A-E show such connectors having a variety of termination options. FIG. 9A shows a simplified view of a multi-element cable connector that terminates in separate wires and tubes.

FIG. 9B shows a simplified view of an embodiment of a connector that terminates in interconnection standards. FIG. 9C shows a simplified end view of an embodiment of a connector that terminates in an application specific conduit assembly. FIG. 9D shows a simplified view of an embodiment of a cable splice or paralleling connector. FIG. 9E shows a simplified view of a blank connector. Dashed lines in the Figures indicate seals made either by bonds, or compression of an insert, or a combination.

Thin rectangles at the sides of the connectors schematically depict mechanical linkages between the connector sides. A multitude of options exist for the location and shape or presence and absence of these mechanical linkages. For example, they can employ threaded fasteners, rivets, ratcheting or latching fasteners, fasteners having spring clips, etc., as known in the art. Bonds can alternatively or in combination be used to hold the connector assembly together.

Drawing inspiration from insulation-displacement connectors for ribbon cables, the connectors of the embodiments shown in FIGS. 9A-E can comprise a plurality of the following:

Insulation displacement electrode blades that slice through the web and make solid electrical contact with conductors.

Crimp, solder, or screw-clamp connections to the conductors to facilitate higher currents.

Fluid interconnections with the flow channels in the web.

An interconnection can be made by piercing, punching, cutting, or melting a hole in the channel and adhesively bonding the surrounding cable material to the connector to minimize leakage. The formation of these cuts and bonds could be automated using a custom-built tool.

Alternatively, the channel could be pierced and a rigid insert placed within the channel at the connector location. The connector could then form a tight compression seal by clamping against the rigid insert.

Another alternative is to pressurize the channels initially with air or another suitable fluid to or draw a relative vacuum around the cable in the region of the connector so the channels inflate to a circular cross section. The connector assembly can then be adhesively bonded, heat-sealed, or glued to the inflated channels before piercing the channels. The adhesive can be incorporated e.g., a pressure-sensitive or heat-sealing adhesive on the connector surface, or installed, e.g., a double-sided tape, curing adhesive, e.g., RTV, silicone, glue, hot glue, or solvent.

Another alternative is to use mechanical interlocking mechanisms which clamp the connector firmly to the cable. These mechanisms could involve mating components on opposite sides of the cable, or interlocks with the web itself, either with slots or holes incorporated into the web or installed via barbed pins or blades that pierce the web or a combination. These mechanisms could also clamp to high-tensile-strength elements to relieve the web material from forces on the connector.

Still other embodiments in accordance with the present invention utilize alignment mechanisms which index elements of the multi-element connector, particularly the channel cavities with their respective connections. These indexing elements may include extruded bumps, bumps surrounding cables and wires, slots or holes incorporated in the web, indicating marks, and the like.

A blank connector can also be an element of an embodiment in accordance with the present invention. Such a connector can serve as a place-holder for an actual connector that allows a pre-assembled cable and connector assembly to be tested and operated without all connectors populated. A blank connector can also be used to seal a connector when one or more modules are being serviced. Alternatively, self-adhesive tape, a curable adhesive-backed patch and the like can be employed to seal more permanently the multi-element cable in the region of a connector that has been removed.

In many cases, electrical power connections include series connections. A simple insulation-displacement or crimp connection scheme only supports parallel connections. A further element of an embodiment in accordance with the present invention is a connector that supports series connections in one or more power circuits by cutting a segment from the electrical conductor and making separate electrical contacts on both sides of the removed segment. In such a system, separate high-tensile-strength cables or fibers are generally needed to prevent cable tensile stresses from transferring to the connector. Alternatively, the connector can be designed such that its connections with the cut wire and its internal strength are sufficiently strong to withstand such tensile loads.

Series fluid connections can be accommodated by a variety of approaches. For example, channel can be sealed shut, e.g., via heat sealing at the location of a series connection and a pair of fluid connections made on opposite sides of the seal according to the previous descriptions. This sealing step could occur during the assembly of the film or in the field, e.g., to allow flexibility in the placement of the connector.

FIG. 4 shows an embodiment of the present invention in which the connector 400 attaches to an otherwise uniform cable. Such an arrangement has the advantage of simple cable manufacturing and allowing a connector to be placed anywhere along the cable, but may suffer disadvantages including increased connector size, larger spacing between connector ports 402, 404, 406 and reliability issues related to a larger seal area along a conduit that employs multiple channels, e.g., element 408.

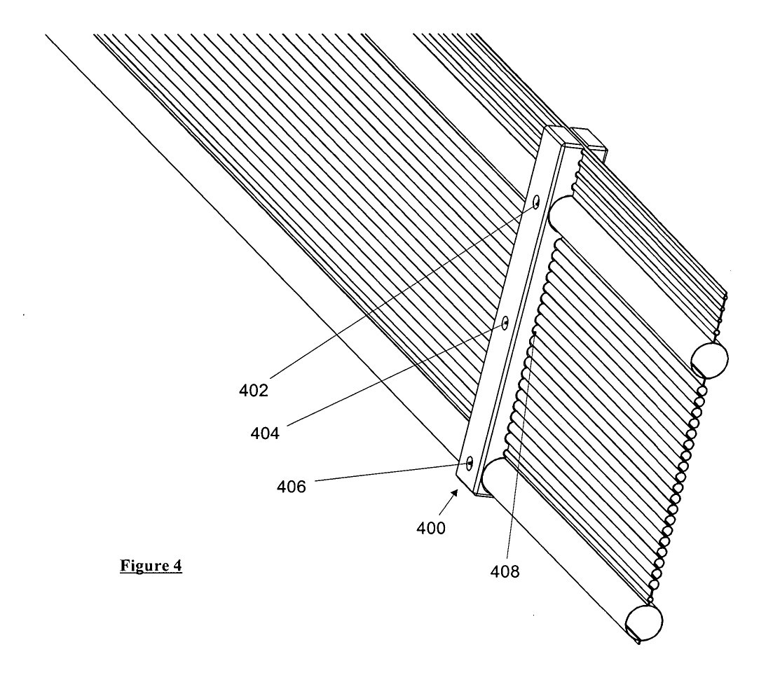

FIGS. 5A-B shows an alternative embodiment 500 of the present invention in which the cable is manufactured to facilitate the use of more compact connectors at specific sites. Common manufacturing processes can support non-uniform channels, such as the plenum 510 that combines the parallel channels 508 and routes them to a single connector mate 512. An air conduit 506 is similarly routed to minimize the connector size. Because the location of a connector is prescribed by they features, a mechanical reinforcement lamination 504 can readily be incorporated at the time of manufacturing.

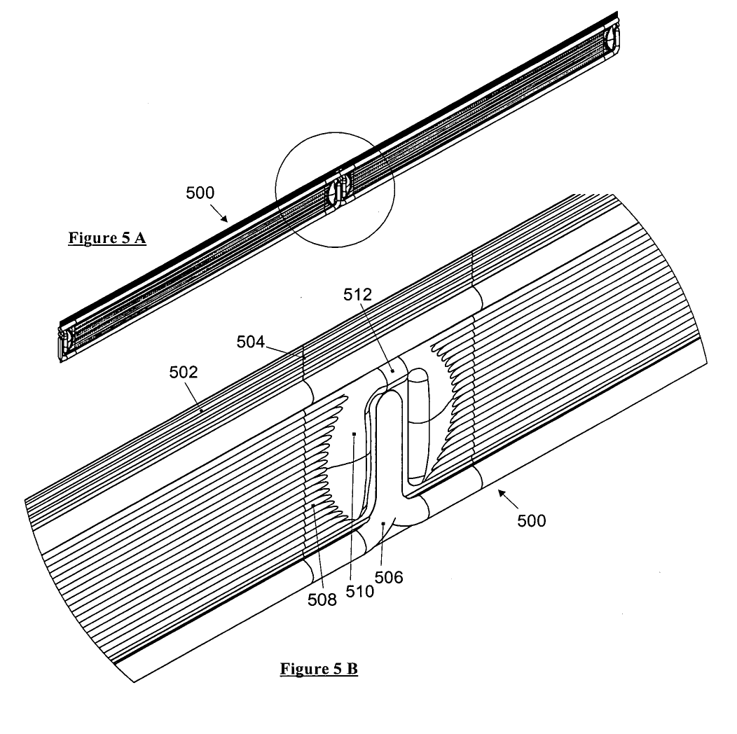

FIGS. 6A-B shows a connector installed or incorporated onto the cable in FIGS. 6A-B. This particular connector design is a “breakout” connector, in which the conduits of the cable are separately routed to a number of separate conventional conduits.

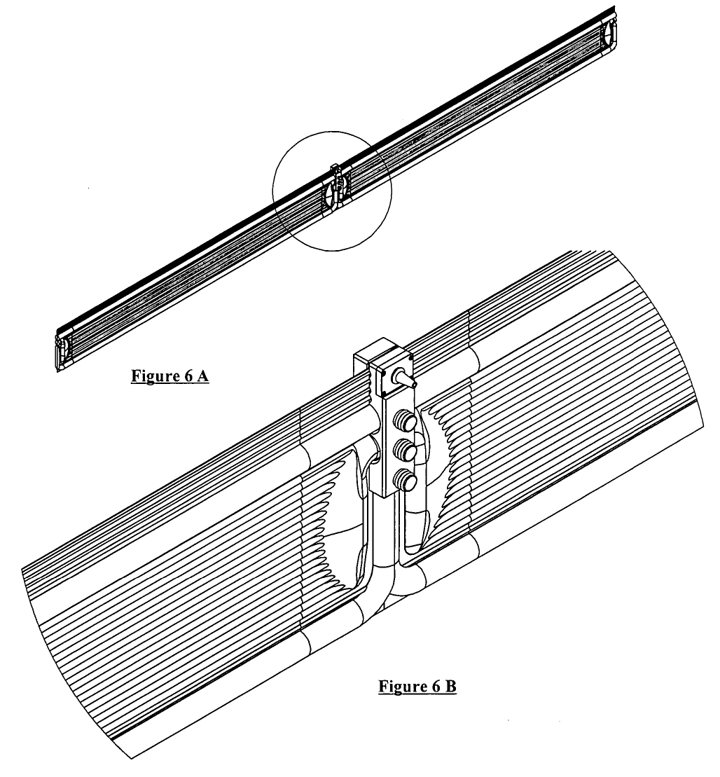

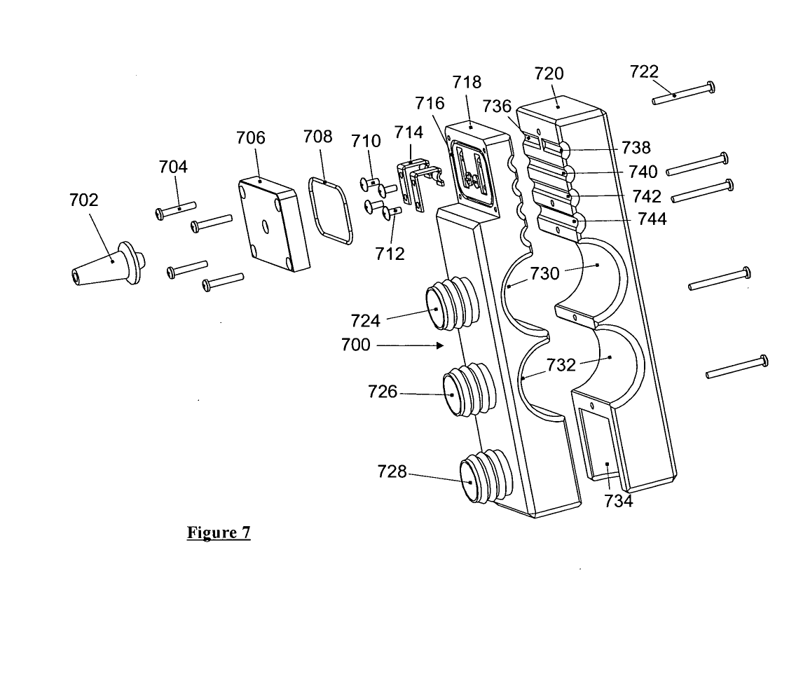

FIG. 7 shows an exploded view of such a breakout connector according to the present invention. In all cases, mechanical connections are shown using screws, but preferred embodiments can alternatively employ the range of mechanical couplers well known in the art, e.g., snap-action connections, Element 702 is a flexible water-sealing grommet and strain relief for electrical wires. Elements 704 are features, possibly incorporated into lid 706 that mechanically hold the lid onto the main connector body 718. In this particular embodiment, a mechanical preload on O-ring 708 in groove 716 provides a long-lifetime removable moisture and water seal to protect exposed electrical contacts 714. Conventional electrical cables pass through grommet 702 and connect to the contacts 714 using, in this embodiment, screwed down crimp connectors. Alternatively any of a number of electrical connection techniques well known in the art could be employed for this purpose provided they have appropriate current capacity and reliability.

The multi-element cable assembly passes through cutouts in the connector body. The top-most cutout 736, 738 is broken in the middle. This broken channel is an example of the connector geometry that can support a series connection. The electrical conductor must be broken in the region between 736 and 738. Separate electrodes 714 connect with the opposite sides of the broken wire. In this embodiment, a mechanical preload provided by fasteners 722 help to ensure the integrity of the electrical contact between electrodes 714 and exposed conductor of the cables in the cutouts 736 and 738. Alternatively, the connections could be made by a variety of techniques well known in the art, e.g., soldering, crimping, insulation displacement, etc.

Connections with electronic signaling wires in cutout 742 could be made using a variety of techniques well known in the art. Preferred techniques can be those that facilitate low-current, high-reliability connections to multiple conductors. In this embodiment, seals between the fluid conduits and connector are employed using adhesives between at least the surfaces 730, 732, and 734 and the multi-element cable.

In this particular embodiment, the standard barbed nipples 724, 726, and 728 provide for connections with external tubing. In alternative embodiments, these connections could be made using a variety of means well known in the art, particularly those that provide for fast and reliable connections. If the client object moves, it may be desirable to employ tubing connections that pivot to avoid kinking or fatiguing tubing.

One particularly favorable feature of a liquid-bearing cable system according to particular embodiments of the present invention is its ability to damp oscillatory or vibrational motions by coupling such motion to displacement and shear of the liquid, which, in turn, dephases and viscously damps the kinetic energy. Such damping is particularly important in low-material-use support structures as those envisioned for large-scale solar farming.

FIG. 10 shows an example of how motion of the support cable can couple into dissipative fluid pumping action. As the mechanical support cable A accelerates upward, the inertia of the cable B and especially the water in the cable causes the cable motion to lag behind the mechanical support. The relative displacement causes the tube cross-sections to become more eccentrically elliptical, lowering the volume capacity of the cable. Liquid is therefore pumped through the pipes in an oscillatory fashion as shown. More liquid is pumped through the cables nearer the mechanical support because of the inertial forces accumulate from the channels below.

FIGS. 11A-C show perspective views of an alternative cable arrangement 1100 according to an embodiment of the present invention, that employs a wide liquid channel or an inertial mass 1106 or separate mechanical cable 1108 to increase the force on the fluid channels 1104 under oscillation of a mechanical cable 1102.

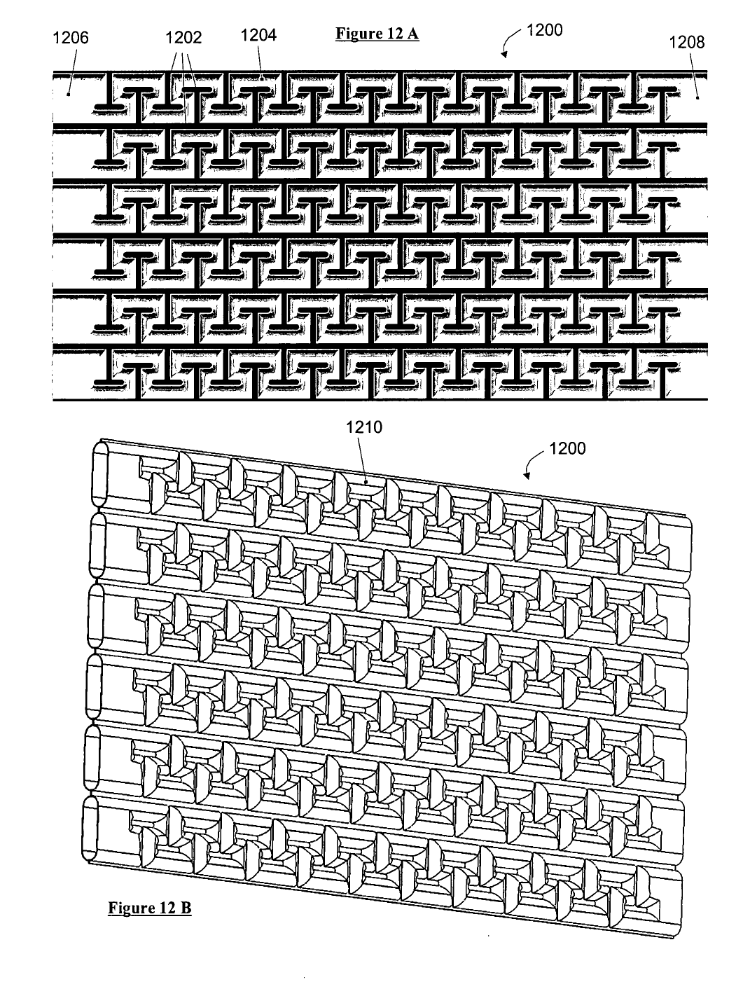

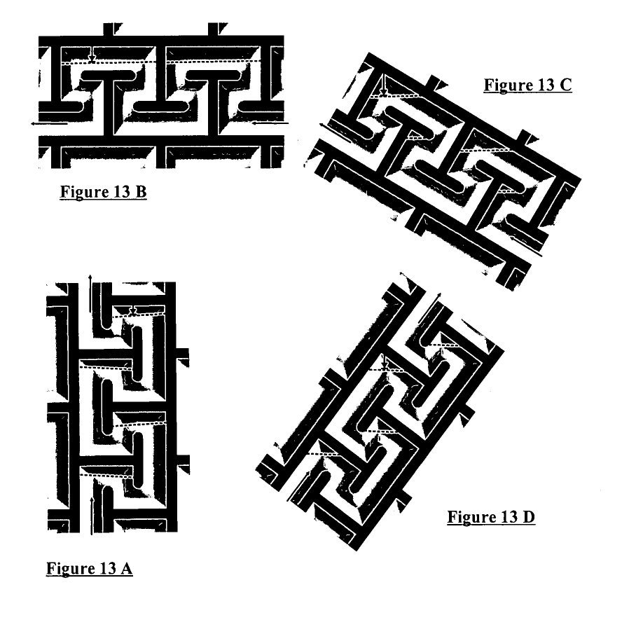

FIGS. 12A-B show plan and perspective views of an alternative liquid conduit arrangement 1200 according to the present invention that employs baffles in the channel and air pockets to create liquid-gas interfaces that are particularly effective at damping vibrations (including translational and rotational). Baffles 1202 produce a tortuous channel path 1204 that can trap air pockets. Such baffles can be made using the same technique that forms laminated segments between adjacent flow channels. Vibrations promote bulk liquid motion and sloshing or wave-breaking behavior at the gas-liquid interface.

FIGS. 13A-D show with dashed lines, the approximate boundary between liquid and gas in the channels of FIGS. 12A-B at various orientations of the channels with respect to gravity. Gas-liquid interfaces persist at all orientations, making this arrangement of channels suitable for damping vibrations in apparatus that must pivot through a range of orientations, e.g., a solar-tracking apparatus.

In accordance with particular embodiments, the multi-element cables can be employed solely for damping. They could be installed with a permanent or replenishable fill of liquid and or gas. Gas can be continuously fed along with liquid through such dampers in the form of bubbles forced or entrained into the liquid flow according to a variety of techniques well known in the art.

While dampening can occur by the presence of a liquid in the connector, in accordance with other embodiments, cavities or channels of the connectors can be filled with one or more slurries, suspensions, colloids, gels, surfactants, phase-change-materials, refrigerants, oils, (e.g., fluorinated, silicone, petroleum, natural, etc.), immiscible fluids, solids such as powders, and/or mixtures of liquid and particles (such as soil, clay, silt, sand, cinders, slag, gravel, polystyrene, latex, sawdust, pulp, etc.)

In accordance with particular embodiments, cavities or channels of the connectors can be filled with wet or substantially dry materials, such as powders, grains, soil, clay, silt, sand, cinders, slag, gravel, polystyrene, latex, foams, sawdust, pulp, post-consumer paper and shredded material, polymers, industrial waste products, etc. and other materials known in the art that can provide damping characteristics.

Having thus described exemplary embodiments of the present invention, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. An apparatus comprising a multiple-element cable containing at least one fluid conduit and a connection selected from an electrical connection, a mechanical connection, and an optical connection, wherein the fluid conduit is defined by a cavity in a web material of the cable.

2. The apparatus of claim 1 wherein the web material comprises a sandwich of bonded plastic films enveloping the connections and forming a wall of the fluid conduit.

3. The apparatus of claim 1 further comprising a second connection selected from an electrical connection, a mechanical connection, and an optical connection.

4. The apparatus of claim 3 wherein the mechanical connection comprises a high-tensile-strength mechanical connection selected from a fiber, a robes, a weave, or a cable.

5. The apparatus of claim 1 wherein the conduit comprises a pneumatic connection or a hydraulic connection.

6. The apparatus of claim 1 wherein the web material comprises a film selected from plastic, metal, fabric, a weave, random fibers, or a combination thereof.

7. The apparatus of claim 1 wherein the cable is partially filled with a material configured to dampen vibration.

8. An apparatus comprising a heat exchanger integrated within a cable housing a connection selected from an electrical connection, a pneumatic connection, a mechanical connection, an optical connection, and a hydraulic connection.

9. The apparatus of claim 8 wherein a wall of the heat exchanger is permeable to a gas or a liquid.

10. A connector configured to mechanically fasten around a cable containing at least one fluid conduit and a connection selected from an electrical connection, a mechanical connection, and an optical connection, the connector establishing a first shunt with the fluid conduit and a second shunt with the connection.

11. The connector of claim 10 configured to provide a series connection of the conduit or the connection.

12. The connector of claim 10 configured to form a fluid-tight seal with the conduit.

13. The connector of claim 10 having a clam shell shape.

14. A method of dampening vibration of a truss, the method comprising:
connecting to at least one tensile truss element, a cable having a cavity configured to be partly filled with a material.

15. The method of claim 14 wherein the cavity is configured to be partially filled with a liquid or a solid.

16. The method of claim 15 wherein the cavity is configured to be partially filled with water, sand, or gravel.

17. The method of claim 14 further comprising a solar energy collector suspended on the truss.

18. The method of claim 17 further comprising controlling a temperature of the suspended solar energy collector through a heat exchanging material present in the connector.

19. The method of claim 17 further comprising communicating electrical power from the suspended solar energy collector through an electrically conducting material present in the connector.

20. A method of controlling a temperature of a suspended solar energy collector, the method comprising:
connecting the airborne solar energy collector through a connector having a cavity containing a heat-exchanging material.

21. The method of claim 20 wherein the cavity contains air, water, or a solid.

22. The method of claim 20 further comprising communicating electrical power from the suspended solar energy collector through an electrically conducting material present in the connector.
